(19) United States
(12) Patent Application Publication
(10) Pub. No.: US 2010/0146088 A1
(43) Pub. Date: Jun. 10, 2010

(54) Apparatus And Method For Effective IPV6 Address In Dial-Up Networking

(76) Inventor: Sing-Il Jin, Seoul (KR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/909,227

(22) PCT Filed: Mar. 20, 2007
(86) PCT No.: PCT/KR07/01352

§ 371 Date: Sep. 20, 2007

(30) Foreign Application Priority Data
Mar. 20, 2006 (KR) 10-2006-0025256

(51) Int. Cl. G06F 15/177

(52) U.S. Cl. 709/222; 709/238

(57) ABSTRACT

Disclosed is an IP address allocator and method thereof for efficiently allocating the Internet Protocol version 6 (IPv6) IP address. Global prefixes allocated to terminals from a single packet data serving node (PDSN) are the same and the PDSN allocates an interface ID to the terminals, thereby preventing repetition of IP addresses between different terminals and allowing easy billing through the same global prefix. Also, since the interface ID is generated to the PDSN based on the global prefix received by the terminal, the load required for generating the interface ID by the PDSN is reduced. Therefore, the waste of IP addresses can be prevented since the IPv6 address is efficiently provided in the cable telephone or mobile telephone network, and the packets are efficiently performed based on the same global prefix since the same global prefix is allocated from a single PDSN.

### TECHNICAL FIELD

The present invention relates to a method and apparatus for allocating an IPv6 IP address, and in particular, it relates to an IP address allocation method and apparatus for efficiently allocating an IPv6 IP address so as to efficiently allocate an IPv6 IP address through a telephone access networking method.

### BACKGROUND ART

Since the Internet Protocol version 6 (IPv6) can use a large volume of address resources, a local router/gateway provided at a terminal or a node area allocates an IP address for each IPv6 prefix (which is a set of bits provided at the initial part of the IPv6 address and is determined by the address type). Therefore, the terminal or the node negotiates the remaining address part other than the prefix with a network access server (NAS) to allocate an interface ID (generated by converting the MAC address) and form an IP address.

However, the IP address generated by a combination of an IPv6 prefix and a negotiated interface ID has a wasteful component. Even though there are plenty of IPv6 IP addresses, the IP address is generated by attaching an ID to a prefix, and hence, the residual prefix band is useless. For example, when the NAS allocates a 64-bit prefix to the terminal or the node, the address of the amount of 2⁶⁴−1 is wasted by telephone access networking. In this instance, the 64-bit prefix is allocated because the 3rd Generation Partnership Project 2 (3GPP2), which is an international mobile communication standard committee, has standardized to allocate a 64-bit prefix to each terminal, and the Internet Engineering Task Force (IETF) standard has also defined to allocate a prefix.

Further, the telephone access networking needs no plurality of IP addresses in most cases since it is low-speed data communication using a point-to-point protocol (PPP). Also, a service provider has a difficulty in billing for the packets for respective IP addresses since it is difficult to bill each IP address by filtering the packets for the respective prefixes when the service provider has allocated the prefixes to the terminal or the node.

### Disclosure

### Technical Problem

The present invention has been made in an effort to efficiently perform general telephone access networking in addition to telephone access networking of a mobile communication network in the case of using IPv6 resources and managing subscribers.

### Technical Solution

In one aspect of the present invention, a method for allocating an IP address in a communication network supporting an IP address including a plurality of identifiers includes: allocating a first terminal identifier for identifying an address of the terminal and transmitting the first terminal identifier to the terminal; receiving a control protocol request message including the first terminal identifier from the terminal; and transmitting a control protocol allowance message for allowing usage of the first terminal identifier included in the received control protocol request message to the terminal; and transmitting a router message including a network identifier to the terminal, the network identifier being allocated to a plurality of terminals within a predetermined same range according to the same manner.

In another aspect of the present invention, an IP address allocator for allocating an IP address in a communication network supporting the IP address including a plurality of identifiers includes: a network identifier allocator for allocating the same network identifier to a plurality of terminals provided to a predetermined area; and a terminal identifier allocator for allocating a terminal identifier to the terminals to which the network identifier is allocated by the network identifier allocators.

In another aspect of the present invention, a method for allocating an IP address in a communication network supporting the IP address including a plurality of identifiers includes: receiving a control protocol request message including a terminal identifier generated by the terminal for identifying an address of the terminal from the terminal; transmitting a control protocol allowance message for allowing usage of the terminal identifier to the terminal; and broadcasting a router message including a network identifier to the terminal, the network identifier being allocated to a plurality of terminals provided to a predetermined same area in a like manner.

### Advantageous Effects

### Description of Drawings

FIG. 1 is a configuration diagram of a general telephone network for using information on the Internet through a telephone access network.

FIG. 2 is a configuration diagram of a mobile station data network supporting the CDMA 1/EV-DO service.

FIG. 3 is a flowchart for an IPv6 data call access process in general mobile communication.

FIG. 4 is a flowchart for an IPv6 data call access process in mobile communication according to a first exemplary embodiment of the present invention.

FIG. 5 is a configuration diagram for an interface ID generator of a terminal according to an exemplary embodiment of the present invention.

FIG. 6 is a flowchart for an IPv6 data call access process in mobile communication according to a second exemplary embodiment of the present invention.

FIG. 7 is a flowchart for an IPv6 data call access process in mobile communication according to a third exemplary embodiment of the present invention.

### BEST MODE

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise”, and variations such as “comprises” and “comprising”, will be understood to imply the inclusion of stated elements but not the exclusion of any other elements.

The current IPv4 Internet uses the limited 32-bit IP address, and the number of IP addresses has become insufficient as Internet usage has gradually increased and the devices using the IP addresses, such as ubiquitous equipment and home networking devices, have increased. To solve the above-noted problem, adoption of the IPv6 address has been discussed, and the introduction of IPv6 address network has been recently discussed.

However, even though the IPv6 has an advantage of allocating a large amount of IP address resources to the subscriber, it causes large address resources to be wasted because of loose address management on the provision of large address resources. The address resource management makes it difficult for the communication service provider to manage users. Accordingly, an efficient method for allocating the IPv6 address resource in the telephone access networking of mobile communication according to an exemplary embodiment of the present invention will be described.

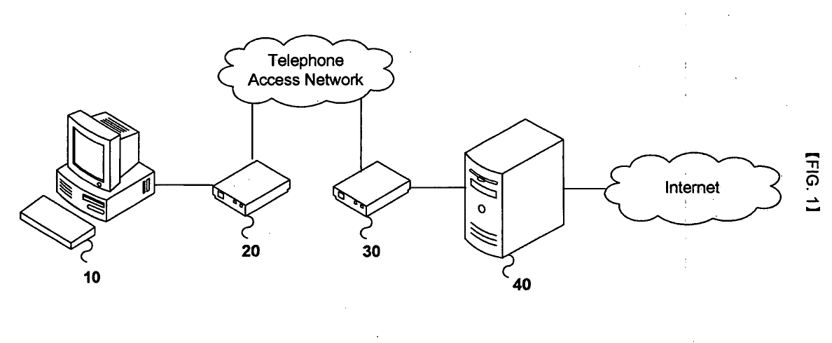

Before describing the IPv6 address resource allocation method, a general telephone network structure, a mobile station data network structure, and a general IPv6 data call access process will now be described with reference to FIG. 1 to FIG. 3.

FIG. 1 is a configuration diagram of a general telephone network for using information on the Internet through a telephone access network.

Referring to FIG. 1, the general telephone network structure for using information given on the Internet through a telephone access network by using a PC includes a PC 10, modems 20 and 30, and a NAS server 40.

Two different networks (not shown) are provided between the NAS server 40 and the client PC 10. The two different networks are a public circuit network provided between the NAS server 40 and the modem 30 and a private circuit network provided between the PC 10 and the modem 20. The modem 20 and the modem 30 are connected by a telephone access network.

An IP network address converter (not shown) is used to convert the address between a local Internet protocol address and an IP global address of the modem 20. The local IP address and a gateway IP address are transmitted to the modem 30, and the same are set to be remote communication network port information after the modem 30 is PPP-connected to the NAS server 40 through the PPP.

A user inputs a local IP address and a subnet mask as IP configuration information to the PC 10, and inputs a local IP address of a modem and one or two domain name service server addresses as a gateway IP address to the PC 10. In this instance, the NAS server 40 is a computer server that is an Internet service provider for providing an Internet service to the user through the PC 10.

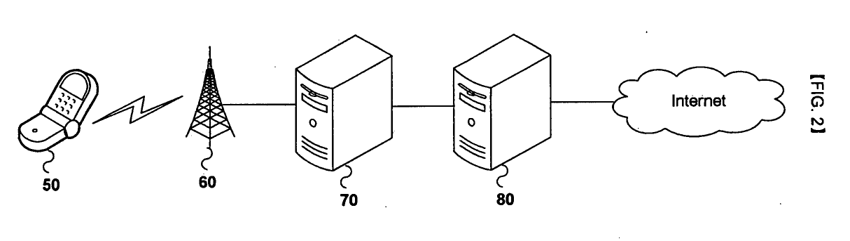

FIG. 2 is a configuration diagram of a mobile station data network supporting the CDMA 1x/EV-DO service.

As shown in FIG. 2, the mobile station data network supporting the CDMA 1/EV-DO service includes a packet data serving node (PDSN), a base station controller (BSC) 70, and a base transceiver station (BTS) 60.

In general, the data network structure of the CDMA-2000 system includes a radio access network (RAN), a voice core network (VCN), and a data core network (DCN). The RAN includes a BTS 60 and a BSC 70, and is an access network for transmitting voice and data to the VCN and the DCN.

The VCN includes a mobile switching center (MSC) and a home location register (HLR), and provides a voice service. The DCN includes a PDSN 80, a home agent, and an authentication, authorization, and accounting (AAA) server, and provides a packet service to a user terminal 50.

The user terminal 50 and the BTS 60 are connected with a radio link, and the BTS 60 and the PDSN 80 are connected with a cable network. The PDSN 80 is connected to a service providing server (not shown) on the Internet through an IP network. In the case of attempting to access the Internet by using the user terminal 50 in the above-noted mobile station data network, the BTS 60 and the BSC 70 can access the Internet by generating a bearer channel for transmitting PPP link data between the terminal 50 and the PDSN 80.

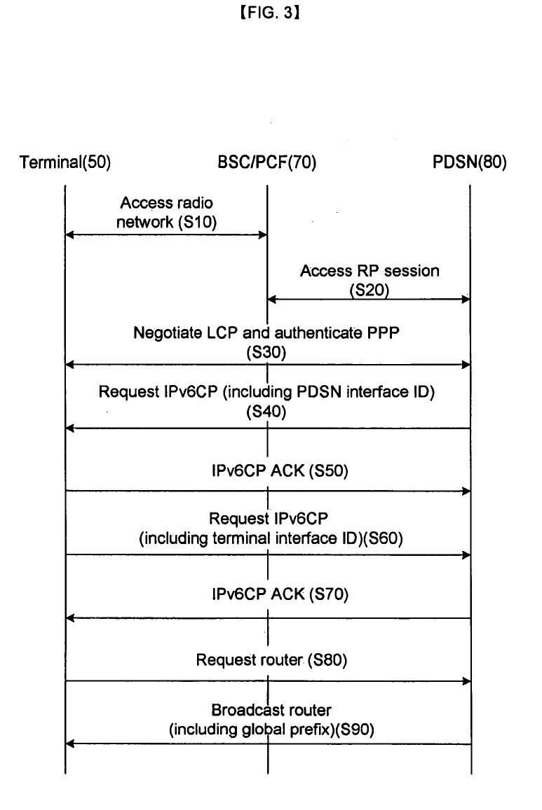

A data call access process for IPv6 address allocation in the mobile communication network will now be described in detail referring to FIG. 3.

FIG. 3 is a flowchart for an IPv6 data call access process in the general mobile communication.

Referring to FIG. 3, the step of a radio network access (S10) is performed between the terminal 50 and the base station controller/packet control function (BSC/PCF) 70, and the step of a radio port (RP) session access (S20) is performed between the BSC/PCF 70 and the PDSN 80. The PPP process (S30) for a call access of the IPv6 in the mobile station network after the RP session access (S20) has three processes of a link control protocol (LCP) process, an authentication process, and an Internet protocol control protocol (IPCP) for IP address allocation process. In this instance, the authentication can be omitted. An IP address is allocated through the PPP process in the cable telephone network in a like manner of the mobile station network.

Regarding the IP address allocation process, the PDSN 80 transmits an IPv6CP configuring request message (S40) so as to notify the terminal 50 of an interface ID (or an identifier) of the PDSN 80, and controls a response message to be authenticated by the terminal (S50). The terminal 50 transmits the IPv6CP configuring request message transmitting the interface ID of the terminal 50 to the PDSN 80 (S60), and the PDSN 80 determines whether the terminal 50 can use the corresponding interface ID, and approves the interface ID when the same is available (S70).

In general, a MAC address is used for the interface ID, or the interface ID is generated by a predetermined method when the terminal or a moving node has no MAC address in the case of the PPP access. Also, the interface ID in this case must be unique on the network. In that case, no address collision is generated with another terminal.

Therefore, the PDSN 80 for allocating an IP to the terminal 50 or managing an IP address of the terminal 50 checks whether repeated interface IDs are found from the terminals managed by the PDSN 80 or checks the repetition of the subsequent network by using the duplicate address detection (DAD) method to determine whether to use an interface ID of the terminal 50. In this instance, the PDSN 80 approves the IPv6 control protocol (IPv6CP) of the terminal 50 by using an ACK message, or transmits a refusal message by using a NACK message to recommend using another ID.

In this instance, regarding the general process for checking the repetition by using the DAD method, the terminal 50 receives a network prefix from the router and generates a 128-bit IPv6 address by applying a MAC address of the terminal 50 to the network prefix. The terminal 50 adds an IP address generated by the terminal 50 to a neighbor solicitation message and transmits the same so as to check whether another terminal uses the same address as the MAC address. When another terminal uses the same address, the corresponding terminal uses a neighbor advertisement message to make a response.

When the IPv6CP process is finished, the terminal 50 requests a router from the PDSN 80 (S80), and the PDSN 80 having received a request on the router from the terminal 50 loads a global prefix ID that is a network identifier on a router advertisement message and allocates the global prefix ID to the terminal 50 (S90). The terminal 50 combines the global prefix ID allocated by the PDSN 80 and the interface ID negotiated with the IPv6CP and uses the combined result as an IPv6 address of the terminal 50. In this instance, the global prefix ID uses 64 bits recommended by 3GPP2 that is the international mobile communication standardization committee.

Since the low-speed PPP communication has no need of setting a plurality of IPs for a single terminal, the address that is used according to the above-noted allocation has a waste factor. That is, the low-speed communication environment only using a single address in the condition in which 2⁶⁴ IP addresses are available is a waste factor. Also, the billing process when the global prefix is continuously changed functions as a load to the billing system in the viewpoint of a service provider, who filters the packets and bills the packets at the PDSN 80 or after the same, or a contents provider (CP).

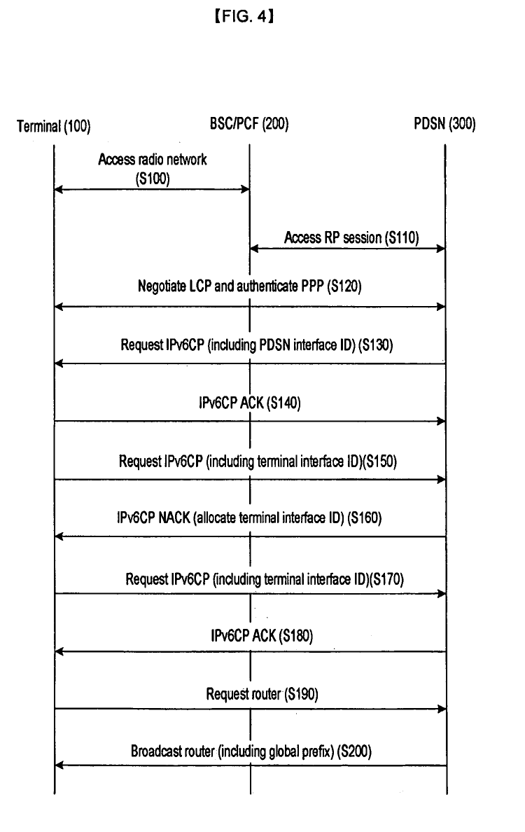

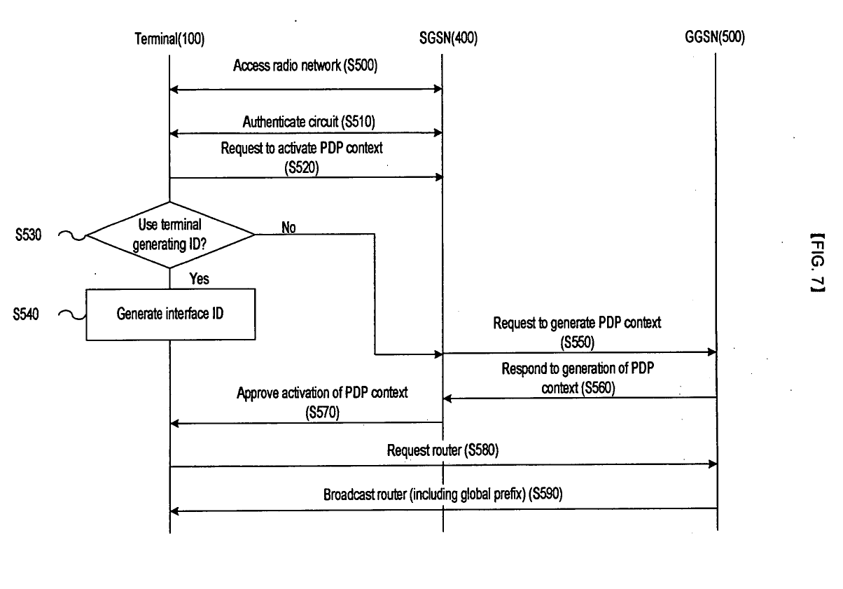

An IPv6 data call access process that is acquired by improving the general data call access process will now be described in detail with reference to FIG. 4. FIG. 4 shows an IPv6 data call process in the CDMA condition, and a data call process in the WCDMA condition will be described later with reference to FIG. 7.

FIG. 4 is a flowchart for an IPv6 data call access process in mobile communication according to a first exemplary embodiment of the present invention.

The IPv6 address generation method is performed by combining the 64-bit prefix allocated to the network and the interface ID of the interface. That is, the entire 128-bit IPv6 address is generated by combining the 64-bit prefix allocated to the router and the MAC address assigned to the interface (or a LAN card). In a similar manner of the existing IPv4 address, the IPv6 address is classified as a manual configuration, a stateful address autoconfiguration caused by address allocation, or a stateless autoconfiguration. A random autoconfiguration will be described in the exemplary embodiment of the present invention, but the embodiment is not limited thereto.

As shown in FIG. 4, regarding the IPv6 data call access process, the terminal 100 applies a radio network access to the BSC/PCF 200 (S100), and performs an RP session access between the BSC/PCF 200 and the PDSN 300 (S110) so as to transmit the data of the terminal 100 to the PDSN 300. Next, a PPP process for performing a link control protocol (LCP) negotiation and PPP authentication between the terminal 100 and the PDSN 300 is performed (S120).

In further detail, when the terminal 100 transmits an origination message to the BSC/PCF 200, the BSC/PCF 200 transmits a base station checking instruction to the terminal 100 to form a traffic channel between the terminal and the BSC/PCF 200 (i.e., a radio network access) (S100).

When the BSC/PCF 200 transmits a registration request message to the PDSN 300, the PDSN 300 registers the terminal's number and session information and transmits a registration response message to the BSC/PCF 200 to thus perform an RP session access (S110). A PPP setting between the terminal 100 and the PDSN 300 is performed, which includes an LCP negotiation and PPP authentication process (S120)

When the PDSN 300 transmits a link control protocol (LCP) configuring request message to the terminal 100, the terminal 100 transmits an LCP configuring unidentified message to the PDSN 300. When the PDSN 300 transmits a link control protocol request message having no authentication option to the terminal 10, the terminal 100 transmits a link control protocol configuring response message to the PDSN 300.

When the terminal 100 transmits an IP configuring protocol configuring request message (IPCP Configure Request) to the PDSN 300 without the IP address option, the PDSN 300 transmits an IPCP configuring response message to the terminal 100 to thus perform the PPP setting process (S120).

When the LCP negotiation and PPP authentication process is performed, the terminal 100 receives an IP address through the PDSN 300 during the IPv6CP process. It is needed to generate an interface ID for the terminal 100 so as to allocate an IP address, and the method for generating the interface ID uses one of the method for allocating an IP address by the terminal and the method for allocating an IP address by the PDSN 300 according to the terminal interface ID allocation method in the general IPv6 data call access process method shown in FIG. 3.

That is, in a like manner of general methods, the terminal 100 allocates the interface ID of the terminal 100 to request the same from the PDSN 300. The PDSN 300 checks repetition of the interface ID requested by the terminal, and when the interface ID is not repeated, the PDSN 300 transmits a corresponding ACK message to the terminal 100 to thus allow usage of the interface ID.

Another telephone access networking method for allocating an IP address to the terminal according to the method for allocating a terminal interface ID to the terminal 100 in the PDSN 300 will now be described.

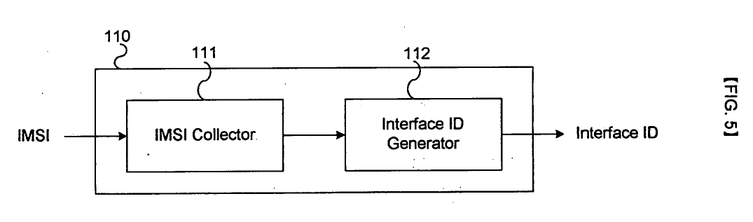

In this instance, the PDSN 300 is also called an IP allocation device together with a GGSN 500 that will be described with reference to FIG. 7. The IP allocation device includes a network identifier allocator for allocating the same network identifier to a plurality of terminals controlled by a predetermined base station, and a terminal identifier allocator for allocating a terminal identifier to the terminals to which the network identifier is allocated from the network identifier allocator. In this instance, as shown in FIG. 5, the terminal identifier allocator determines whether to allocate a terminal identifier when the interface ID is generated by the terminal, and the terminal identifier allocator collects the terminal identifier from the terminal when the same is not set to allocate the terminal identifier.

The PDSN 300 transmits an IPv6CP configuration request message so as to notify the terminal 100 of the interface ID of the PDSN 300 (S130). The terminal 100 transmits an acknowledgement (ACK) message to the PDSN 300 in response to it (S140) to thus approve the IPv6CP configure request on the interface ID of the PDSN 300.

In this instance, the terminal 100 transmits an IPv6CP configure request message (S150) so as to transmit the interface ID to the PDSN 300. On receiving the approval request message on the interface ID of the terminal 100, the PDSN 300 rejects the interface ID that is transmitted by the terminal 100 by including the interface ID into the IPv6CP request message, and the PDSN 300 recommends a new interface ID to the terminal (S160).

An interface ID is generated as a random value to the terminal initially accessing the PDSN 300, and the value of “the interface ID value initially allocated to the terminal +1” is allocated to the next accessed terminal. In this instance, the PDSN 300 allocates the interface ID to the terminal by using the point at which the global prefixes are the same. The global prefixes are statically allocated to the respective PDSNs.

That is, the PDSNs can be provided to respective areas, and the PDSNs in the different areas respectively have a unique global prefix that can be allocated to each different terminal. Therefore, since the PDSN allocates the same global prefix to all the terminals managed by the PDSN, it is needed to allocate a different IP address to each terminal so that only one terminal is managed by the single PDSN.

The PDSN can know which ID is managed by the PDSN from among the interface IDs allocated to a plurality of terminals, and hence, the PDSN rejects the interface ID requested by the terminal, randomly allocates an interface ID, and recommends the same to the terminal. In this instance, the round robin method is used to allocate the interface ID to the terminal, but the embodiment is not limited thereto.

The terminal 100 includes the terminal interface ID allocated by the PDSN 300 into the IPv6CP request message and requests the PDSN 300 to check the terminal interface ID (S170), and the PDSN 300 transmits an IPv6CP ACK for notifying allowance to the terminal 100 (S180). When the IPv6CP process is finished, the terminal 100 transmits a router solicitation (or a router request) message to the PDSN 300 (S190) by using the interface ID newly allocated by the PDSN 300 so as to acquire network information (or global prefix information) from the router.

On receiving the router solicitation message from the terminal 100, the PDSN 300 loads a global prefix ID on the router broadcasting message and broadcasts the same so as to allocate the global prefix ID to the terminal 100 (S200). In this instance, the global prefix Ds allocated by a single PDSN to the terminals are the same. That is, all the terminals managed by the PDSN receive the same global prefix ID in the router broadcasting process.

The reason for this is that no IP addresses are repeated between the different terminals since the unique interface ID is allocated to all the terminals in the IPv6CP stage. That is, the IP address of the terminal given as “global prefix ID+terminal interface ID” is not repeated. Therefore, the resource of the IP address is less wasted.

Also, in the case of charging the packets at the PDSN or at the network after the PDSN, it is easy to charge the packets since one global prefix is provided to all the terminals managed by the PDSN 300 because there are a lot of processes to be matched and calculated by the billing system when the global prefixes are respectively different and because the calculation is reduced since the part after the interface ID is separated and calculated when the global prefixes are the same.

An interface ID generator of a terminal 100 for generating an interface ID and notifying the PDSN 300 of the terminal's interface ID, and an interface ID according to a second exemplary embodiment of the present invention will now be described. A configuration of the terminal will now be described with reference to FIG. 5.

FIG. 5 is a configuration diagram for an interface ID generator of a terminal according to an exemplary embodiment of the present invention.

As shown in FIG. 5, the terminal 100 includes an interface ID generator 110, which includes an international mobile station identity (IMSI) collector 111 and an interface ID generator 112. FIG. 5 shows the interface ID generator 110 included in the terminal 100, and other elements will not be described since they are well known to a person skilled in the art.

The IMSI collector 111 collects the IMSI showing the proper number for identifying the terminal 100. In general, the IMSI includes a 3-digit mobile country code (MCC), a 2- to 3-digit mobile network code (MNC), and a maximum 10-digit mobile subscriber identifier number (MSIN), and hence, the IMSI is expressed as a maximum 15-digit decimal number.

The IMSI collected by the IMSI collector 111 is input to the interface ID generator 112 to generate an interface ID of the terminal 100. The interface ID has 64 bits and is generated by using the IMSI of the terminal 100.

For example, assuming that the IMSI of the terminal 100 is given as “123456789123456”, the IMSI is converted into the binary number of “000100100011010001010110011110001001000100100011010001010110”. Since the temporary interface ID generated in this instance has 60 bits, 0 is provided before the temporary interface ID, after the temporary interface ID, or at a predetermined position selected by the system designer to fill another 4 bits and thereby generate the 64-bit interface ID. The method for generating the interface ID by using the IMSI is not restricted to the above description.

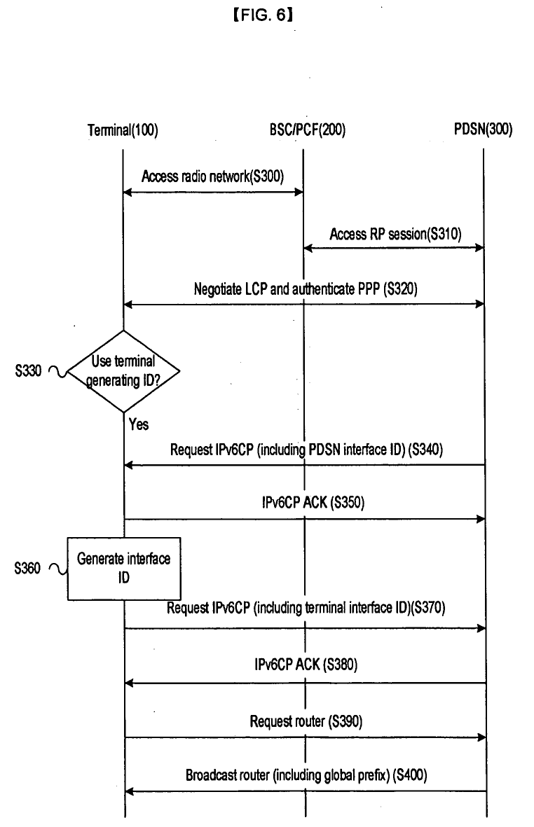

An IPv6 data call access process in the condition of generating an interface ID by the terminal 100 will now be described with reference to FIG. 6.

FIG. 6 is a flowchart for an IPv6 data call access process in mobile communication according to a second exemplary embodiment of the present invention.

As shown in FIG. 6, the terminal 100 performs a radio network access to the BSC/PCF 200 (S300), and performs an RP session access between the BSC/PCF 200 and the PDSN 300 so as to connect the data of the terminal 100 to the PDSN 300 (S310). Next, a PPP process for performing link control protocol (LCP) negotiation and PPP authentication between the terminal 100 and the PDSN 300 is performed (S320).

In detail, when the terminal 100 transmits an origination message to the BSC/PCF 200, the BSC/PCF 200 transmits a base station checking instruction to the terminal 100 to perform a radio network access for forming a traffic channel between the terminal and the BSC/PCF 200 (S300).

When the BSC/PCF 200 transmits a registration request message to the PDSN 300, the PDSN 300 registers the terminal's number and session information and transmits a response message to the BSC/PCF 200 to thus perform an RP session access (S310). Next, a PPP setting is performed between the terminal 100 and the PDSN 300. The PPP setting process includes an LCP negotiation and PPP authentication process (S320).

When the PDSN 300 transmits an LCP configuring request message to the terminal 100, the terminal 100 transmits a link control protocol configuring unidentified message to the PDSN 300. When the PDSN 300 transmits a link control protocol request message without the authentication option, the terminal 100 transmits a link control protocol configuration response message in response to it.

When the LCP negotiation and PPP authentication process is all performed as described above, the terminal 100 receives an IP address through the PDSN 300 in the IPv6CP process. It is needed to generate an interface ID for the terminal 100 so as to allocate an IP address, and the interface ID generating method uses the IMSI of the terminal 100 and a telephone access networking method for allocating an Internet protocol address to the terminal according to the method of notifying the PDSN 300 of the generated terminal interface ID.

First, the terminal 100 determines whether to use an ID that is allocated by the PDSN 300 or an ID that is generated by the interface ID generator 110 as an interface ID (S330). In this instance, the interface ID is selected by realizing a software-based switch function into the terminal 100, which is designed by a system designer.

When the switch function of the terminal is set to be on, the terminal 100 uses the interface ID generated by the interface ID generator 110, and when the same is set to be off, the terminal 100 uses the interface ID allocated by the PDSN 300. However, the embodiment is not restricted to the above description.

When it is determined to use the interface ID generated by the PDSN 300 in S330, a telephone access networking stage for allocating an Internet protocol address to the terminal is performed through the steps from S130 to S200 shown in FIG. 4. However, when it is determined for the terminal 100 to use the interface ID generated by the terminal, the PDSN 300 transmits an IPv6CP configuring request message so as to notify the terminal 100 of the interface ID (S340). The terminal 100 transmits an acknowledgement (ACK) message to the PDSN 300 (S350) in response to it, to approve the IPv6CP configuring request on the interface ID of the PDSN 300.

In this instance, the terminal 100 receives a prefix from the PDSN 300 and simultaneously transmits the IPv6CP configuring request message so as to transmit the interface ID generated by the terminal 100 to the PDSN 300 (S370). In this instance, the interface ID included in the IPv6CP configuring request message is generated by the interface ID generator 110 of the terminal 100 (S360). That is, the terminal 100 uses the IMSI of the terminal to generate an interface ID to be used by the terminal 100, and notifies the PDSN 300 of generation of the interface ID. On receiving an approval request message on the interface ID of the terminal 100, the PDSN 300 approves the interface ID that is transmitted by the terminal 100 after the interface ID is included into the IPv6CP request message (S380).

When the IPv6CP process is finished, the terminal 100 transmits a router solicitation (or a router request) message to the PDSN 300 (S390) by using the interface ID that is generated by using the IMSI by the interface ID generator 110 of the terminal 100 so as to acquire network information (or global prefix information) from the router. On receiving the router solicitation message from the terminal 100, the PDSN 300 loads a global prefix ID on the router broadcasting message and broadcasts the same so as to allocate the global prefix ID to the terminal 100 (S400).

Assuming that the PDSN 300 receives the interface ID generated in S360 by the terminal 100 and the PDSN 300 simultaneously generates an interface ID for the terminal to the terminal 100 according to the method described with reference to FIG. 4, the PDSN 300 is set to select the interface ID generated by the interface ID generator 110 of the terminal 100 other than the interface ID of the terminal generated by the PDSN 300 when designing the system. However, the embodiment is not restricted thereto.

Next, an IPv6 data call access process method when the system uses the WCDMA scheme will be described with reference to FIG. 7.

FIG. 7 is a flowchart for an IPv6 data call access process in mobile communication according to a third exemplary embodiment of the present invention.

As shown in FIG. 7, a signal processing and circuit authentication process for a radio network access between a terminal 100 and a serving GPRS support node (SGSN) 400 is performed (S500, S510), which corresponds to the radio network access stage and LCP negotiation and PPP authentication stage shown in FIG. 4 and FIG. 6, and which shows a circuit authentication process on a traffic channel after forming the traffic channel between the terminal 100 and the SGSN 400

When the process up to the circuit authentication is performed, the terminal 100 receives the IP address generated by the GGSN 550 or the terminal 100. It is needed to generate an interface ID for the terminal 100 so as to allocate the IP address, and the interface ID is generated by using one of the method for generating the interface ID by using the IMSI by the terminal 100 or the method for allocating the interface ID by the GGSN 500.

For this, the terminal 100 determines whether to use the interface ID that is allocated by the GGSN 500 or the interface ID that is generated by the terminal 100 (S530). In this instance, the usage on the interface ID that is generated by one of the methods is selected by realizing software functioning as a switch for the terminal 100, and the software is designed by a system designer.

When the switching function of the terminal is set to be on, the terminal 100 uses the interface ID generated by the terminal 100 and notifies the GGSN 500 to the corresponding usage, and when the switching function of the terminal is set to be off, the terminal 100 uses the interface ID allocated by the GGSN 500. However, the embodiment is not restricted to this.

When the switching function of the terminal 100 is set to be off according to the determination result of S530 and the interface ID generated by the GGSN 500 is determined to be used, an activate PDP context request is transmitted to the SGSN 400 so as to receive an interface ID from the GGSN 500 (S520). The SGSN 400 transmits a create PDP context request to the GGSN 500 (S550) based on the activate PDP context request received from the terminal 100 to allocate an interface ID to the terminal 100.

The GGSN 500 generates a create PDP context response message in response to the activate PDP context request received from the SGSN 400 and transmits the same to the SGSN 400 (S560). In this instance, the message includes interface ID information corresponding to a single PDP context in order to reduce the resource waste of the IP addresses by allocating the same prefix to all the terminals reaching a single GGSN area since a single terminal may have different PDP contexts

The SGSN 400 receives a PDP context response message including the interface ID of the terminal from the GGSN 500, and transmits an activate PDP context accept message to the terminal (S570). When the above-noted process is finished, the terminal uses the interface ID newly received from the GGSN to transmit a router solicitation message to the GGSN 500 (S580). On receiving the router solicitation message from the terminal, the GGSN 500 loads a global prefix ID on the router broadcasting message and broadcasts the same so as to allocate the global prefix ID to the terminal 100 (S590). In this instance, the global prefix IDs allocated to the terminals by a single GGSN are all the same. That is, all the terminals managed by the GGSN receive the same global prefix ID in the router broadcasting process.

In this instance, when the terminal 100 does not use the terminal interface ID allocated by the GGSN but desires to use the terminal interface ID generated by the terminal 100 according to the determination result of S530 (when the switching function is set to be on), the terminal uses the IMSI of the terminal to generate an interface ID, include the same into the message, and to transmit the same before transmitting an activate PDP context request message to the GGSN 500. The method for the terminal 100 to generate the interface ID corresponds to that described with reference to FIG. 5.

The subsequent process corresponds to the step of S550. Here, FIG. 7 shows that the steps from S520 to S540 are sequentially performed, although the embodiment is not restricted to sequential performance, and the interface ID generated by the terminal 100 is loaded onto the activate PDP context request message and is transmitted to the SGSN 400.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to the exemplary embodiment, the IPv6 address is efficiently provided on the cable telephone network or mobile telephone network, thereby preventing the waste of IP addresses. Also, since the same global prefix is allocated from a single PDSN or a GGSN, the packets are efficiently billed based on the same global prefix.

1. A method for allocating an IP address in a communication network supporting an IP address including a plurality of identifiers, the method comprising:
allocating a first terminal identifier for identifying an address of the terminal and transmitting the first terminal identifier to the terminal;
receiving a control protocol request message including the first terminal identifier from the terminal; and
transmitting a control protocol allowance message for allowing usage of the first terminal identifier included in the received control protocol request message to the terminal; and
transmitting a router message including a network identifier to the terminal, the network identifier being allocated to a plurality of terminals within a predetermined same range according to the same manner.

2. The method of claim 1, wherein
the allocating of a terminal identifier and transmitting of the terminal identifier to the terminal includes:
receiving a control protocol request message including a second terminal identifier generated by the terminal from the terminal so as to identify the address of the terminal; and
transmitting a control protocol rejecting message for rejecting usage of the second terminal identifier included in the received control protocol request message to the terminal, the rejecting message including the first terminal identifier.

3. The method of claim 2, wherein
the first terminal identifier is allocated based on the identifier of the terminal.

4. The method of claim 1, wherein
the transmitting of the router message includes:
receiving a router solicitation message from the terminal; and
on receiving the router request message, transmitting a router broadcasting message including the network identifier allocated to the terminal to the terminal.

5. The method of claim 1, wherein
packet billing for the terminal is performed based on the sameness of the network identifier.

6. The method of any one of claim 1 to claim 5, wherein
the IP address is formed by a combination of a 64-bit network identifier and a 64-bit first terminal identifier based on the IPv6 address method.

7. An IP address allocator for allocating an IP address in a communication network supporting the IP address including a plurality of identifiers, the IP address allocator comprising:
a network identifier allocator for allocating the same network identifier to a plurality of terminals provided to a predetermined area; and
a terminal identifier allocator for allocating a terminal identifier to the terminals to which the network identifier is allocated by the network identifier allocators.

8. A method for allocating an IP address in a communication network supporting the IP address including a plurality of identifiers, the method comprising:
receiving a control protocol request message including a terminal identifier generated by the terminal for identifying an address of the terminal from the terminal;
transmitting a control protocol allowance message for allowing usage of the terminal identifier to the terminal; and
broadcasting a router message including a network identifier to the terminal, the network identifier being allocated to a plurality of terminals provided to a predetermined same area in a like manner.

9. The method of claim 8, wherein the method further includes
checking repetition of the terminal identifier included in the request message after the step of receiving the request message, wherein
the checking of repetition includes checking repetition of the terminal identifier according to duplicate address detection (DAD).

10. An IP address allocator in a communication network supporting the IP address including a plurality of identifiers, the IP address allocator comprising:
a network identifier allocator for allocating the same network identifier to a plurality of terminals provided to a predetermined area; and
a terminal identifier allocator for determining whether to allocate the identifier of the terminal, and collecting the terminal identifier from the terminal when it is set not to allocate the identifier of the terminal.

11. The IP address allocator of claim 10, wherein
the terminal includes:
a proper number collector for collecting a proper number of the terminal that is stored corresponding to the terminal; and
an interface ID generator for generating a terminal identifier for identifying the terminal based on the collected proper number of the terminal, and transmitting the terminal identifier to the terminal identifier allocator.

12. A method for allocating an IP address in a communication network supporting the IP address including a plurality of identifiers, the method comprising:
receiving a control protocol message including a system identifier for identifying an address of the system from the system for supporting the IP address;
receiving an allowance message for allowing usage of a first terminal identifier for identifying an address of the terminal from the system, the first terminal identifier being generated from the system; and
receiving a router broadcasting message including a network identifier from the system, the network identifier being allocated to a plurality of terminals managed by the IP address supporting system in a like manner.

13. The method of claim 12, wherein
the receiving of the allowance message includes:
transmitting a first control protocol request message including a second terminal identifier allocated by the terminal;
receiving a rejection message for the first control protocol request message, the rejection message including a first terminal identifier generated by the system; and
transmitting a second control protocol request message including the first terminal identifier included in the rejection message, and receiving an allowance message for allowing the usage of the first terminal identifier.

14. A method for allocating an IP address in a communication network supporting the IP address including a plurality of identifiers, the method comprising:
transmitting a control protocol request message including a terminal identifier allocated by the terminal to the system supporting the IP address;
receiving an allowance message for allowing the usage of the terminal identifier; and
receiving a router broadcasting message including a network identifier, the network identifier being allocated to a plurality of terminals within a predetermined same area.

15. The method of claim 14, wherein
the terminal includes:
using a proper number of the terminal to generate a terminal identifier and transmitting the terminal identifier to the system supporting the IP address; and
receiving an allowance message for allowing the usage of the terminal identifier from the system supporting the IP address, and receiving the router broadcasting message including the network identifier from the system supporting the IP address.

16. The method of claim 15, wherein
the transmitting of the message including the terminal identifier includes:
collecting a proper number of the terminal;
converting the proper number into a binary number; and
determining the number of bits of the binary proper number, and inserting a predetermined value for satisfying the number of bits of the terminal identifier to generate the terminal identifier.

17. The method of claim 14, wherein
selecting to use a terminal identifier from among the terminal identifier generated by the system supporting the IP address and the terminal identifier generated by the terminal;
receiving a first terminal identifier for identifying an address of the terminal generated by the system supporting the IP address when the terminal identifier generated by the system supporting the IP address is selected; and
receiving an allowance message for allowing the usage of the first terminal identifier, and transmitting a router message including the network identifier to the system supporting the IP address.
